(19) United States
(12) Patent Application Publication
(10) Pub. No.: US 2020/0248893 A1
(43) Pub. Date: Aug. 6, 2020

(54) LED LAMP

(71) Applicant: Ki Ho JEON, Dongducheon-si (KR)

(72) Inventor: Ki Ho JEON, Dongducheon-si (KR)

(21) Appl. No.: 15/774,514

(22) PCT Filed: Nov. 3, 2016
(86) PCT No.: PCT/KR2016/012568

§ 371 Date: May 8, 2018

(30) Foreign Application Priority Data
Nov. 12, 2015 (KR) 20-2015-0007356
Nov. 12, 2015 (KR) 20-2015-0007357

(51) Int. Cl. F21V 15/015; F21L 4/00; F21V 3/04; F21K 9/65; F21V 17/12; F21V 21/10; F21V 23/04

(52) U.S. Cl. CPC F21V 15/015; F21L 4/005; F21V 3/049; F21Y 2115/10; F21V 17/12; F21V 21/10; F21V 23/0414; F21K 9/65

(57) ABSTRACT

An LED lamp according to an embodiment of the present invention uses an LED, which can implement a high-luminance light source with less power than an existing normal lightbulb, such that, while enabling the same to be carried, it is possible to realize all of various functions, for example, the function of a lantern, a flashlight, a light bar, or a flash signal light.

### TECHNICAL FIELD

The present invention relates to an LED lamp.

### RELATED ART

In general, people use lanterns in the night, in dark places, at home and during outdoor activities such as camping, fishing, climbing, trekking etc. Such lanterns are divided into two categories. One category is directly supplied with power to be turned on and the other is supplied with power by a built-in battery to be turned on.

Further, these lanterns use bulbs as a light source. However, these days, LEDs are generally used to ensure the long lifespan and large amount of light.

Such LED lanterns are often used to light up the inside of a tent, to confirm fishing hooks and types of fish, and to light up the surroundings. While carrying out outdoor activities such as climbing, trekking etc., people use LED lanterns in the night and in dark places.

Further, various type of lanterns with different structures are used to illuminate the surroundings and work places if there is not enough light in the basement and indoor spaces or if there is no lighting in the basement and indoor spaces.

However, such LED lanterns are used only to light up the surroundings. This means that these lanterns may not function as a light bar or a signal bar.

In general, police officers control traffic, ensure public safety, guide vehicles at construction sites or at accident sites, notify other vehicles that there is car that is broke down, and ensure the safe movement of army vehicles by using light bars or signal bars in the event that it is hard to acquire a clear view, for instance, in the dark or in the rain.

Such signal bars are turned on and emit light in the night etc. so as to send optical signals thereby helping acquire a clear view and allowing the police officers to perform the above-described jobs.

However, conventional light bars or signal bars only perform their own functions. They may not function as a lantern. As a result, a lantern, a light bar, a signal bar etc. should be provided separately. This causes inconvenience and result in a financial burden.

### Prior Art Document

### Patent Document

Korean Utility Model Publication No. 20-2011-0005713

### DETAILED DESCRIPTION OF THE INVENTION

### Technical Problems

The present invention is devised to solve the above-described problems and is directed to providing an LED lamp capable of performing functions of a lantern or a flashlight only by means of rotation of a cover provided to the LED lamp, and capable of performing functions of a light bar or a flash signal light by means of installation of an outer cover or an outer body.

### Technical Solutions

An LED (light-emitting diode) lamp according to an embodiment of the present invention includes a casing having any one end thereof, to which a rear cap is inserted and fixed, an inside thereof, into which a battery is built, and any one lateral side thereof, to which a stitch is provided; a printed circuit board (PCB) having electrically connected LEDs that are arranged at the PCB so as to receive power provided by the battery built into the casing; a cylindrical cover having any one end thereof, to which a front cap is inserted and fixed, and transmitting light that is radiated by the LEDs of the PCB; and a coupling mouth installed to couple the cover to the casing such that the cover may rotate in place, wherein the coupling mouth includes a cylindrical body, which is fixed to one end of the casing so as to be placed between the casing and the cover, and an insertion coupling part which is formed at the body so as to couple the cover such that the cover may rotate in place, the cover rotatably coupled to the insertion coupling part is configured to be a white light diffusion tube such that the light may diffuse when the light radiated by the LEDs passes through the cover, the light diffusion tube has a plurality of transparent lenses that are formed in a row at a certain portion of the light diffusion tube, and the transparent lens or the light diffusion tube is positioned toward the LEDs by means of the rotation of the cover such that the LED lamp may selectively perform any one function of a lantern or a flashlight.

The transparent lenses are configured to be regularly spaced apart from each other at the cover along a longitudinal direction thereof and may be configured to be corresponding to the LEDs arranged at the PCB.

The coupling mouth may have a screw coupling part with a spiral part formed at an inner circumferential surface of the screw coupling part so as to screw an outer cover installed to cover up the cover, and the outer cover coupled to the screw coupling part may be configured to have a red color such that the LED lamp may be used as a light bar.

An LED lamp according to another embodiment of the present invention includes a bar-shaped casing with a hollow part or a tube-shaped casing such that a battery may be provided inside the casing; a printed circuit board (PCB) which is positioned close to an outside of the casing and at which electrically connected LEDs are arranged so as to receive power provided by the battery; left and right end caps, which have a supporter which is fixed to one surface of the PCB and whose both ends protrude from the PCB so as to support the PCB, which are installed at both ends of the casing such that both ends of the supporter may be inserted and coupled to the left and right end caps, which have a coupling groove formed at inner sides of the left and right end caps so as to insert and couple both ends of the supporter protruding from the PCB, and which have a switch capable of controlling power provided to the LEDs formed at an outside of the left and right end caps; and a cylindrical cover, whose both ends are coupled to the left and right end caps, which has the PCB positioned at the center of an inside of the cylindrical cover, which transmits light radiated by the LEDs of the PCB, and which is mounted onto any one surface of the casing so as to rotate in place, wherein the casing is configured to have a rectangular stick shape or tube shape and to have a mounting surface which is formed at an upper surface of the casing, configured to be corresponding to an outer circumferential surface of the cover, configured to have a semicircular shape, and configured to be dug inwards, the cover has both ends thereof which are couple to the left and right end caps such that the cover may be mounted onto the mounting surface of the casing and may rotate in place, the end caps have a ring-shaped insertion coupling part such that both ends of the cover may be inserted into and coupled to the ring-shaped insertion coupling part thereby allowing the cover to rotate in place, the cover coupled to the ring-shaped insertion coupling part to rotate in place is configured to be a white light diffusion tube such that the light may diffuse when the light radiated by the LEDs passes through the cover, the light diffusion tube has a plurality of transparent lenses that are formed in a row at a certain portion of the light diffusion tube, and the transparent lens or the light diffusion tube is positioned toward the LEDs by means of the rotation of the cover such that the LED lamp may selectively perform any one function of a lantern or a flashlight.

The transparent lenses are configured to be regularly spaced apart from each other at the cover along a longitudinal direction thereof and may be configured to be corresponding to the LEDs arranged at the PCB.

The LED lamp includes an outer body which helps perform a function of a flash signal light by means of insertion of the LED lamp in an emergency, wherein the outer body includes an outer cover which consists of a material transmitting red light and is configured to have a cylindrical shape with a hollow structure in which both ends of the outer cover are opened so as to insert the LED lamp; left and right tops which prevents the LED lamp, which is coupled to both ends of the outer cover and is inserted into the outer cover, from escaping from the outer cover; and a tripod which is installed at the left and right tops but is foldably installed at any one of the left and right tops so as to erect the outer cover such that the light radiated by the LEDs may be expressed as a red color and may let the LED lamp perform a function of a flash signal light in the state in which the LED lamp is inserted into the outer cover, wherein a magnet is installed at any one of the left and right tops such that the outer cover to which the left and right tops are coupled may be attached and fixed to a separate metal in the state in which the tripod is folded.

Besides the descriptions that have been provided above, other aspects, features and advantages of the present invention will become apparent on the basis of the drawings, the descriptions of the embodiment and the appended claims which will be described hereunder.

### Advantageous Effects

According to the present invention, one LED lamp may perform functions of a lantern, a flashlight as well as a light bar or a flash signal light. Accordingly, the present invention is effective in promoting convenience and reducing costs.

Further, an LED lamp according to the present invention may be used by police officers as a traffic baton and as a lantern and a flashlight during night patrols, and as a tool to suppress demonstrations or arrest criminals. Police officers may use the LED lamp as a means to arrest criminals by pointing the light to the eyes of a criminal and as a means to ensure their safety when they suppress demonstrations during the night. Accordingly, they do not need to use separate lighting apparatuses or vehicles equipped with lighting.

### BRIEF DESCRIPTION OF THE DRAWINGS

FIG. 1 is a perspective view illustrating an LED lamp according to an embodiment of the present invention used as a flashlight, and

FIG. 2 is a sectional view illustrating an LED lamp cut along the I-I line in FIG. 1.

FIG. 3 is a perspective view illustrating an LED lamp according to the present invention used as a lantern, and

FIG. 4 is a sectional view illustrating an LED lamp cut along the II-II line in FIG. 3.

FIGS. 5 and 6 are perspective views respectively illustrating one surface and the opposite surface of a cover provided to an LED lamp according to the present invention.

FIG. 7 is an exploded perspective view illustrating the structure of an LED lamp according to the present invention.

FIG. 8 is a perspective view illustrating the state in which an outer cover is separated from an LED lamp according to another embodiment of the present invention used as a light bar.

FIG. 9 is an enlarged view illustrating the portion at which the outer cover in FIG. 8 is coupled to a coupling mouth.

FIG. 10 is an enlarged view illustrating portion “A” in FIG. 9.

FIG. 11 is a view illustrating a step of assembling an outer cover.

FIG. 12 is a perspective view illustrating an LED lamp according to another embodiment of the present invention used as a flashlight, and

FIG. 13 is a sectional view illustrating an LED lamp cut along the III-III line in FIG. 12.

FIG. 14 is a perspective view illustrating an LED lamp according to another embodiment of the present invention used as a lantern, and

FIG. 15 is a sectional view illustrating an LED lamp cut along the IV-IV line in FIG. 14.

FIGS. 16 and 17 are perspective views respectively illustrating one surface and the opposite surface of a cover provided to an LED lamp according to another embodiment of the present invention.

FIG. 18 is an exploded perspective view illustrating the structure of an LED lamp according to another embodiment of the present invention.

FIG. 19 is an exploded perspective view illustrating the structure of an LED lamp according to yet another embodiment of the present invention,

FIG. 20 is a perspective view illustrating the LED lamp according to the embodiment in FIG. 19, and

FIGS. 21 and 22 are views illustrating an LED lamp used as a flashlight or a lantern by means of rotation of the cover provided to the LED lamp according to the embodiment in FIG. 19.

FIG. 23 is a view illustrating the state in which the LED lamp according to the present invention is inserted into an outer body so as to be used as a flash signal light.

FIG. 24 is a view illustrating an LED lamp used as a flash signal light by means of a tripod provided to the outer body in FIG. 23 to erect the outer body.

### MODE FOR CARRYING OUT THE INVENTION

Before the present invention is described, the descriptions of specific structures and functions that will be provided below are given as examples only to describe embodiments according to the concept of the present invention. Accordingly, it should be understood that the present invention may be embodied in various different forms and should not be limited to the embodiments set forth herein.

Further, specific embodiments will be illustrated in the drawings and described in detail in this specification since the present invention according to the concept thereof may be modified in various ways and embodied in various different forms. However, the embodiments of the present invention should not be construed as being limited to the ones specifically disclosed. Rather, the embodiments are intended to include various modifications, equivalents and alternatives thereof within the technical spirit and scope of the present invention.

Below, an LED lamp according to an embodiment of the present invention will be described with reference to FIGS. 1 to 7.

An LED Lamp according to an embodiment of the present invention has a casing 110. The casing 110 functions as a handle of the LED lamp. The casing may have the shape of a container or a circular cylinder, and both ends of the cylinder are opened. A battery 112 may be built into the casing 110. The battery 112 may be a rechargeable lithium-ion battery or a disposable battery but not limited to a rechargeable lithium-ion battery or a disposable battery. The casing 110 may have an inner structure corresponding to a size of the built-in battery 112. The casing 110 may consist of aluminum or plastic injected objects but not be limited to aluminum or plastic injected objects.

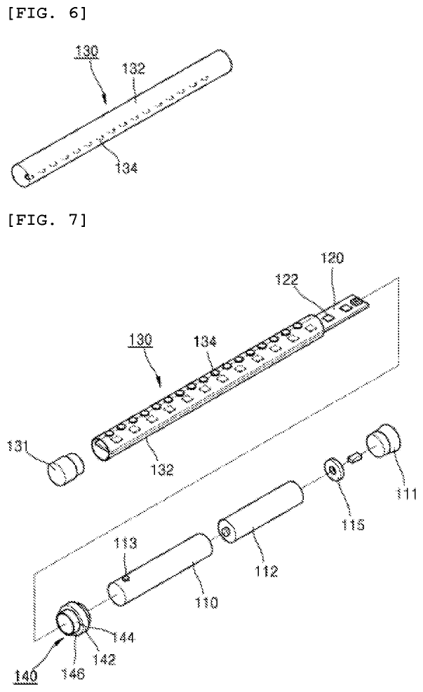

In the casing 110, a magnet 115 may be configured to be adjacent to a rear cap 111 (see. FIG. 7). The magnet 115 may play a role in fixing a location of the battery 112 inside the casing 110. Further, a string (invisible) may be installed at the casing 110 or the rear cap 111 such that the casing or the rear cap may be hung from the wrist of the user.

The rear cap 111 is inserted into and fixed to any one end of the casing 110. The rear cap 111 has an insertion part that is inserted into the casing 110, and an exposure part that is exposed to an outside of the casing 110. In this case, a radius of the insertion part may be the same as an inner radius of the casing 110. The rear cap 111 plays a role not only in preventing the battery 112, magnet 115 etc. in the casing 110 from escaping from the casing 110 but also in enabling the user to hold the casing 110 more easily. Accordingly, a diameter of the rear cap 111 may increase from the exposure part that is exposed to the outside of the casing 110 to an outer surface of the rear cap. The rear cap 111 may consist of plastic or rubber.

A switch 113 is provided at any one lateral side of the casing 110. The switch 113 is electrically connected to the battery 112 so as to turn on and off an LED 122 which will be described hereunder. In the event that a PCB, which will be described hereunder, has a controller (invisible), the switch may be manipulated to control the brightness and operations of the LED 122. For instance, the LED 122 may function as an emergency flicker, which is turned on and off at regular intervals. Meanwhile, one switch is illustrated in the drawings, but the switch 113 may be configured to be a plurality of switches. For instance, one switch is used to turn on and off the LED, and another is used to control the brightness of the LED.

An LED lamp according to an embodiment of the present invention has a printed circuit board 120. The PCB 120 is inserted into a cover 130, which will be described below. The PCB 120 is electrically connected so as to receive power provided by the battery 112 built into the casing 110. The PCB 120 includes a plurality of LEDs 122, and a circuit connecting the LED 122, switch 113 and battery 112.

The plurality of LEDs 122 are arranged on the PCB 120. The LEDs 122 radiates light by means of the power provided by the battery 112. The LEDs 122 may be configured to be regularly spaced apart from each other on the PCB 120.

The LED 122 may radiate white light but is not limited to an LED radiating white light. For instance, the LED 122 may include various LEDs such as an LED radiating white light, an LED radiating red light, and an LED radiating yellow light. Such an LED 122 is connected to the switch 113 and a controller (invisible) etc. of the PCB 120 such that the LED may be controlled to selectively radiate white light/red light/Yellow light.

An LED lamp according to an embodiment of the present invention has a cover 130. The cover 130 consists of a material capable of transmitting light such as acryl or glass etc. As a result, the light radiated by the LED 122 passes through the cover 130 and is released outwards. The cover 130 plays a role in protecting the PCB 120 and the LED 122 inside the cover 130. A front cap 131 is inserted into and fixed to any one end of such a cover 130. The front cap 131 has an insertion part that is inserted into the casing 110, and an exposure part that is exposed to an outside of the casing 110. In this case, a radius of the insertion part may be the same as an inner radius of the casing 110. The front cap 131 may consist of plastic or rubber.

Meanwhile, the front cap 131 may be configured to have a structure in which an inside of the front cap 131 is dug such that the flat surface type PCB 120 may be inserted. In this case, the front cap 131 is inserted into and fixed to the cover 130 such that locations of the cover 130 and the PCB 120 may be fixed.

An LED lamp according to an embodiment of the present invention has a coupling mouth 140. The coupling mouth 140 couples the cover 130 to the casing 110 such that the cover 130 may rotate in place.

With reference to FIG. 7, the coupling mouth 140 has a cylindrical body 142 that is fixed to one end of the casing 110 so as to be placed between the casing 110 and the cover 130. Further, the coupling mouth 140 has an insertion coupling part 144 that is formed at the body 142 to couple the cover 130 such that the cover 130 may rotate in place. That is, the casing 110 and the cover 130 are coupled at both sides of the coupling mouth 140. In this case, it is important that the cover 130 is coupled so as to rotate in place.

With reference to FIGS. 5 and 6, the cover 130 is configured to be a white light diffusion tube 132 such that the light radiated by the LEDs 122 inside the cover may diffuse, the light diffusion tube 132 has a plurality of transparent lenses 134 that are formed in a row at a certain portion of the light diffusion tube 132, and the transparent lens 134 or the light diffusion tube 132 is positioned on upper portions of the LEDs 122 by means of the rotation of the cover 130 connected to the coupling mouth 140 such that the LED lamp may selectively perform any one function of a lantern or a flashlight. This is the feature of the present invention.

According to an embodiment, transparent lenses 134 are configured to be regularly spaced apart from each other at the cover 130 along a longitudinal direction thereof and may be configured to be corresponding to the LEDs 122 arranged on the PCB 120. That is, the transparent lens 132 may be seen to be overlapped with the LEDs 122 when the LED lamp is seen from a bird's eye view because the transparent lenses 132 may be configured to be corresponding to the LEDs 122.

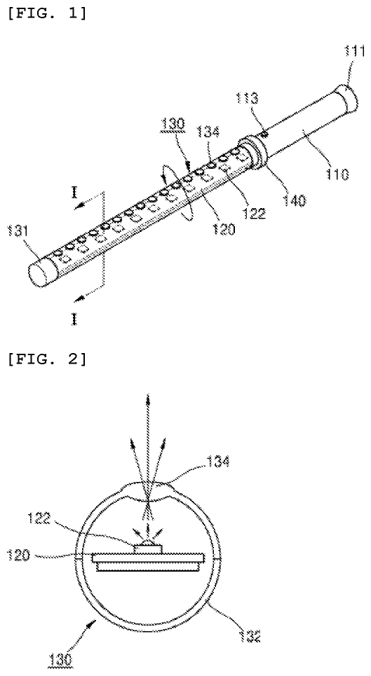

As illustrated in FIGS. 1 and 2, if the cover 130 configured to be a light diffusion tube 132 rotates such that the transparent lenses 134 positioned at a certain portion of the light diffusion tube 132 are placed at upper ends of the LEDs 122, the light radiated by the LEDs 122 passes through the transparent lens 134 and is released intensively toward upper ends of the cover 130. In this case, the LED lamp functions as a flashlight.

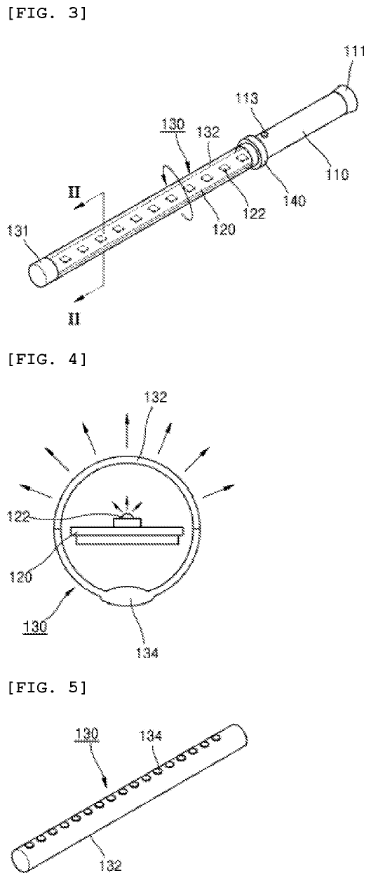

Meanwhile, as illustrated in FIGS. 3 and 4, if the cover 130 rotates in place such that the light diffusion tube 132 is placed at upper ends of the LEDs 122, the light radiated by the LEDs 122 is diffused and released through the light diffusion tube 132 and evenly spreads in all directions. In this case, the LED lamp functions as a lantern.

That is, depending on the in-place rotation of the cover 240, the LED lamp according to the present invention selectively functions as a flashlight or a lantern, and the user may selectively use the LED lamp according to the present invention as a flashlight or a lantern.

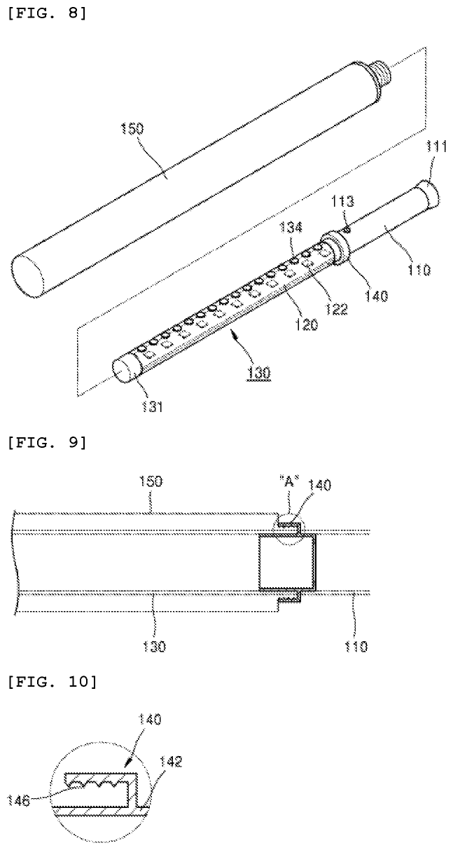

With reference to FIG. 8, a separate outer cover 150 may be installed to cover up the cover 130. The outer cover 150 may be configured to have the shape of a circular cylinder shape with a hollow inside and may have a spiral part-shaped coupling part which is formed at one end of the outer cover 150 and coupled to the coupling mouth 140. An LED lamp having the outer cover 150 may function as a light bar. For instance, even when the LED 122 radiates white light, the LED covered with a red outer cover 150 radiates red light. Accordingly, in this case, the LED lamp may be used as a light bar to notify danger. The red outer cover 150 may be used such that the LED lamp is used as a light bar. However, the color of the outer cover may not be limited to a red one. The outer cover 150 may consist of a material capable of transmitting light such as acryl, glass, polycarbonates (PC) etc.

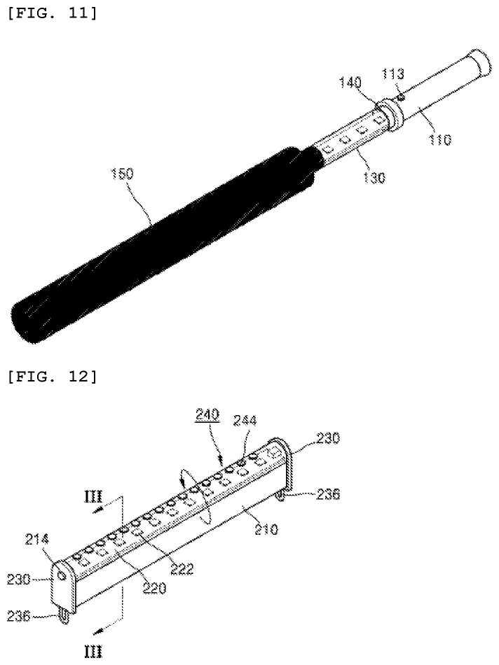

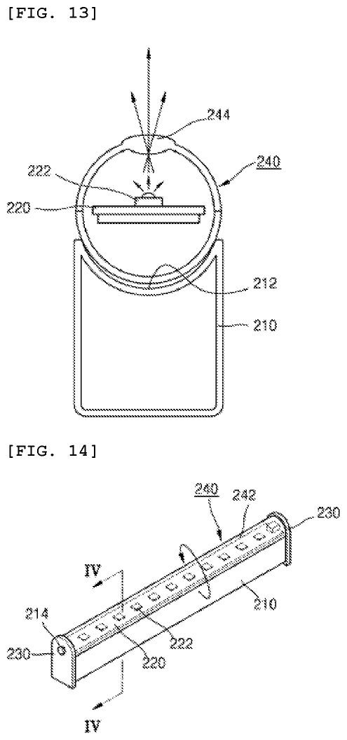

According to an embodiment, a coupling mouth 140 may have a screw coupling part 146 with a spiral part formed at an inner circumferential surface of the screw coupling part so as to screw the outer cover 150 installed to cover up the cover 130. With reference to FIGS. 9 and 10, the screw coupling part 146, in a sectional view, may be configured to protrude a longitudinal direction of the outer cover 150. After the cover 13 is inserted into the outer cover 150 such that the outer cover 150 covers up the cover 130, the outer cover 150 may rotate to be screwed into the screw coupling part 146.

An LED lamp according to the present invention may be used by police officers as a traffic baton, as a lantern and a flashlight during night patrols, and as a tool to suppress demonstrations or arrest criminals. Police officers may use the LED lamp as a means to arrest criminals by pointing the light to the eyes of a criminal and as a means to ensure their safety when they suppress demonstrations during the night. Accordingly, they do not need to use separate lighting apparatuses or vehicles equipped with lighting. The present invention has the advantage of performing functions of a lantern, a flashlight and a light bar etc. thereby resulting in a reduction in costs and ensuring safety of police officers.

FIGS. 12 to 18 are views illustrating an LED lamp according to another embodiment of the present invention, and the difference between an LED lamp according to the above-described embodiments and an LED lamp according to another embodiment of the present invention will be described.

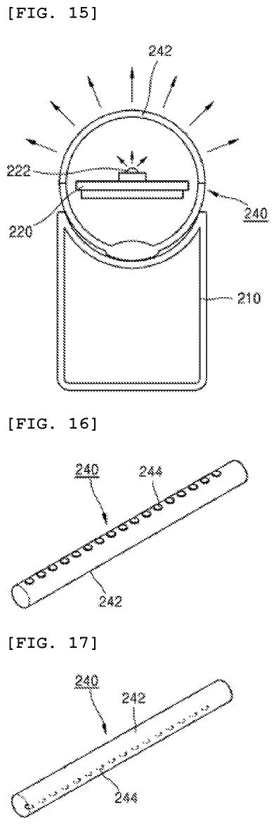

First, with reference to FIG. 14, an LED lamp according to another embodiment of the present invention has a casing 210. The casing 210 may be configured to have a bar shape or tube shape whose both ends are opened and which has a hollow inside. That is, the casing 210 is configured to have a rectangular stick shape or tube shape and has a mounting surface 212 which is, for instance, formed at an upper surface of the casing, configured to have a semicircular shape, and configured to be dug inwards. The casing 210 may consist of aluminum or plastic injected objects but not be limited to aluminum or plastic injected objects.

With reference to FIG. 18, a battery 216 may be built into the casing 210. The battery 216 provides power to a PCB 220, which will be described hereunder. For instance, so as to provide power and to be recharged through a USB cable, a recharging pin 218 may be provided inside the casing 210. The recharging pin 218 may be configured to be exposed to an outside of an end cap 230, which will be described hereunder.

A cover 240, which will be described hereunder, is positioned on a mounting surface 212 of the casing 210. The cover 240 consists of a material capable of transmitting light such as acryl or glass. As a result, light radiated by an LED 222, which will be described hereunder, passes through a cover 240 and is released outwards. The cover 240 plays a role in protecting the PCB 220 and the LED 222 inside the cover 240.

Both ends of the casing 210 and the cover 240 have left and right end caps 230. The left and right end caps 230 fix relative locations of the casing 210, the cover 240, the PCB 220.

The PCB 220 is positioned at the center of an inside of the cover 240, and a plurality of LEDs 222 are arranged on the PCB 220. In this case, the PCB 220 is supported by a supporter 224.

The supporter 224 is fixed to one surface of the PCB 220, and both ends of the supporter 224 are configured to protrude from the PCB 220. Accordingly, both ends of the supporter 224 is inserted into and coupled to the left and right end caps 230. To this end, a coupling groove 232 is formed at inner sides of the left and right end caps such that both ends of the supporter 224 protruding from the PCB 220 may be inserted and coupled.

Meanwhile, the cover 240 mounted onto the mounting surface 212 of the casing 210 is coupled to the left and right end caps 230 so as to rotate in place. With reference to FIG. 18, the left and right end caps 230 have a ring-shaped insertion coupling part 234 to which both ends of the cover 240 are inserted and coupled thereby allowing the cover 240 to rotate in place. When both ends of the cover 240 are inserted into and coupled to the insertion coupling part 234, the cover 240 may rotate in place.

As described above, the cover 240 that is coupled to the insertion coupling part 234 to rotate in place may include a white light diffusion tube 242 so as to diffuse light when the light radiated by the LEDs 222 passes through the cover 240. A plurality of transparent lens 244 may be positioned in a row at a certain portion of the light diffusion tube 242.

According to an embodiment, transparent lenses 244 are positioned to be regularly spaced apart from each other at the cover 240 along a longitudinal direction thereof and may be positioned to be corresponding to the LEDs 222 arranged on the PCB 220. That is, the transparent lens 344 may be seen to be overlapped with the LEDs 222 when the LED lamp is seen from a bird's eye view because the transparent lenses 244 are placed to be corresponding to the location of the LEDs 222.

As illustrated in FIGS. 12 and 13, if the cover 240 rotates such that the transparent lenses 244 are placed at upper ends of the LEDs 222, the light radiated by the LEDs 222 passes through the transparent lens 244 and is released intensively toward upper ends of the cover 240. In this case, the LED lamp functions as a flashlight.

Meanwhile, as illustrated in FIGS. 14 and 15, if the cover 240 rotates such that the light diffusion tube 242 is placed at upper ends of the LEDs 222, the light radiated by the LEDs 222 is diffused and released through the light diffusion tube 242 and evenly spreads in all directions. In this case, the LED lamp functions as a lantern. That is, depending on the in-place rotation of the cover 240, the present invention selectively functions as a flashlight or a lantern. This is the feature of the present invention.

In this case, the mounting surface 212 of the casing 210 may consist of material such as metal or glass with high reflectivity. In this case, the light radiated by the LEDs 222 toward the casing 210 reflects off the mounting surface 212. As a result, a large amount of light reflects toward an upper surface of the cover 240, which does not contact the casing 210, thereby improving luminous efficiency.

Meanwhile, with reference to FIG. 12, a hanging hook 236 may be installed at outer sides of the left and right end caps 230. Through the hanging hook 236, an LED lamp according to the present invention may be hung by a string. In this case, the hanging hook 236 is provided to both sides of the LED lamp such that the LED lamp according to the present invention may be hung horizontally.

FIGS. 19 to 22 are views illustrating an LED lamp according to yet another embodiment of the present invention.

According to an embodiment, left and right end caps 230 coupled to both ends of the cover 240 may have a coupling part coupled to the cover 240, a protrusion part protruding from one side of the coupling part, and a handle 231 may be provided between the protrusion parts.

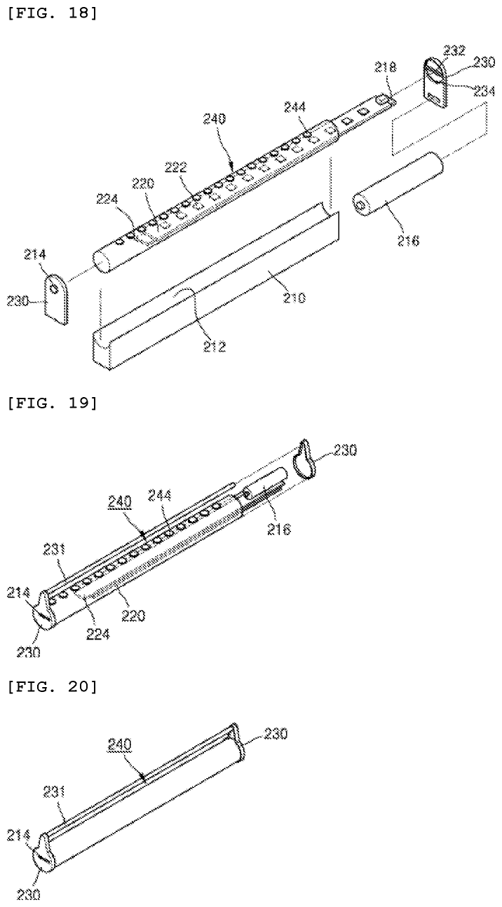

With reference to FIG. 20, each of the left and right end caps 230 has a coupling part with a circular shape and a protrusion part protruding upwards in the shape of the letter V. The handle 231 is positioned between each protrusion part of the left and right end caps 230. The LED lamp according to the present invention may be easily gripped and used by means of the handle 231.

Meanwhile, a battery 216 may be provided inside the cover 240 not the casing 110, 210 because a separate handle 231 is provided. In this case, a fixing part (invisible) is provided inside the cover 240 to fix a location of the battery 216.

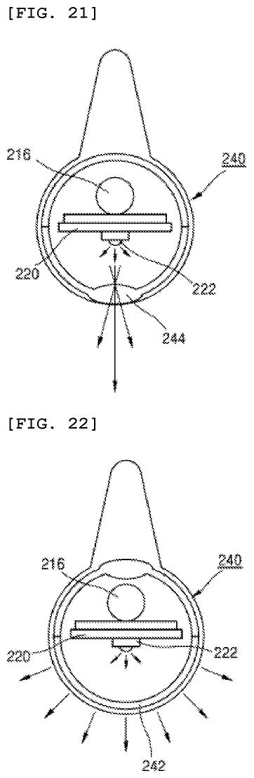

As illustrated FIG. 21, if the cover 240 rotates such that the transparent lens 244 is placed at lower ends of the LEDs 222, light radiated by the LEDs 222 passes through the transparent lens 244 and is intensively released toward a lower end of the cover 240. In this case, the LED lamp functions as a flashlight.

Meanwhile, as illustrated in FIG. 22, if the cover 240 rotates such that the light diffusion tube 242 is placed at lower ends of the LEDs 222, the light radiated by the LEDs 222 is diffused and released through the light diffusion tube 242 and evenly spreads in all directions. In this case, the LED lamp functions as a lantern. That is, depending on the in-place rotation of the cover 240, the present invention selectively functions as a flashlight or a lantern.

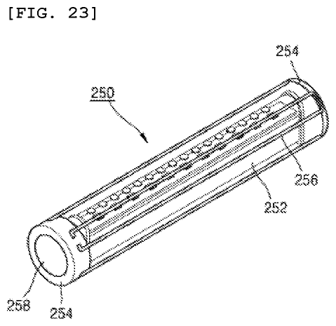

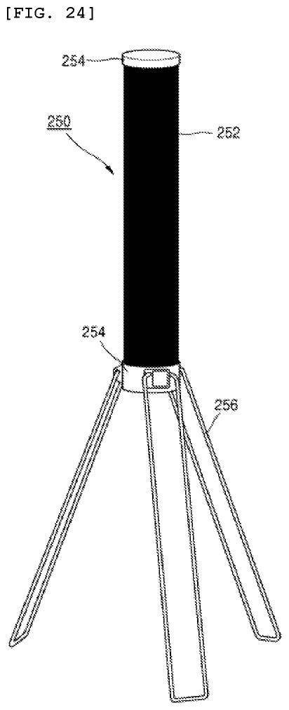

Below, with reference to FIGS. 23 and 24, an LED lamp according to yet another embodiment of the present invention will be described.

FIG. 23 is a view illustrating a state in which the LED lamp according to the present invention is inserted into an outer body so as to be used as a flash signal light, and FIG. 24 is a view illustrating an LED lamp used as a flash signal light by means of a tripod provided to the outer body in FIG. 23 to erect the outer body.

An LED lamp according to the present invention may further include an outer body 250 which helps perform a function of a flash signal light through insertion of the LED lamp in an emergency.

The outer body 250 includes an outer cover 252, left and right tops 254 and a tripod 256. The outer cover 252 consists of a material transmitting red light and has a cylindrical shape with a hollow structure in which both ends of the outer cover are opened so as to insert the LED lamp.

Left and right tops 254 prevents the LED lamp, which is coupled to both ends of the outer cover 252 and inserted into the outer cover 252, from escaping from the outer cover 252. A tripod 256 is configured to be foldably installed at any one of the left and right tops 254 so as to erect the outer cover 252.

By means of the above-described tripod 256, light radiated by the LEDs 222 may be expressed as a red color and allows the LED lamp to perform a function of a flash signal light in a state in which the LED lamp is inserted into the outer cover 252

Further, a magnet 258 is installed at any one of the left and right tops 254 such that the outer cover 252 to which the left and right tops 254 are coupled may be attached and fixed to a separate metal in a state in which the tripod is folded. Such a magnet 258 may be installed at the top 254 at a side at which the tripod 256 is installed.

That is, an LED lamp according to the present invention is inserted into the outer body 250 so as to be used as a flash signal light. That is, an LED lamp according to the present invention is inserted into the outer cover 252 and erected by the tripod 256 so as to be installed at the rear of a vehicle in the case of a car accident. Accordingly, the LED lamp may be used in a convenient manner.

According to the present invention, the cover 130, 240 rotates so as to place the light diffusion tube 132, 242 or the transparent lens 134, 244 toward the LEDs 122, 222 such that the LED lamp may function as a lantern or a flashlight. That is, the user may select any one of the functions. Further, by means of the outer cover 150 or the outer body 250 which covers up the cover 130, 240, the LED lamp may function as a light bar or a flash signal light. This means that one LED lamp may perform functions of a lantern and a flashlight as well as a light bar or a flash signal light thereby ensuring convenient use and a reduction in costs.

The technical problems will be solved on the basis of the above-described technical features of the present invention. The invention has been described in relation to its limited embodiments and drawings. However, the present invention should not be construed as being limited to the embodiments and drawings set forth herein. It should be understood that the present invention may be changed and modified by those skilled in the art to which the present invention pertains in various different forms within the appended claims and equivalents thereof.

### INDUSTRIAL APPLICABILITY

The present invention is applicable to an LED lamp.

1. An LED (light-emitting diode) lamp comprising:
a casing having any one end thereof, to which a rear cap is inserted and fixed, an inside thereof, into which a battery is built, and any one lateral side thereof, to which a stitch is provided;
a printed circuit board (PCB) having electrically connected LEDs that are arranged at the PCB so as to receive power provided by the battery built into the casing;
a cylindrical cover having any one end thereof, to which a front cap is inserted and fixed, and transmitting light that is radiated by the LEDs of the PCB; and
a coupling mouth installed to couple the cover to the casing such that the cover may rotate in place,
the coupling mouth comprising:
a cylindrical body which is fixed to one end of the casing so as to be placed between the casing and the cover; and
an insertion coupling part which is formed at the body so as to couple the cover such that the cover may rotate in place,
wherein the cover rotatably coupled to the insertion coupling part is configured to be a white light diffusion tube such that the light may diffuse when the light radiated by the LEDs passes through the cover, the light diffusion tube has a plurality of transparent lenses that are formed in a row at a certain portion of the light diffusion tube, and the transparent lens or the light diffusion tube is positioned toward the LEDs by means of the rotation of the cover such that the LED lamp may selectively perform any one function of a lantern or a flashlight.

2. The LED lamp according to claim 1, wherein the transparent lenses are configured to be regularly spaced apart from each other at the cover along a longitudinal direction thereof and may be configured to be corresponding to the LEDs arranged at the PCB.

3. The LED lamp according to claim 1, wherein the coupling mouth has a screw coupling part with a spiral part formed at an inner circumferential surface of the screw coupling part so as to screw an outer cover installed to cover up the cover,
the outer cover coupled to the screw coupling part is configured to have a red color.

4. An LED lamp comprising:
a bar-shaped casing with a hollow part or a tube-shaped casing such that a battery may be provided inside the casing;
a printed circuit board (PCB) which is positioned close to an outside of the casing and at which electrically connected LEDs are arranged so as to receive power provided by the battery;
left and right end caps, which have a supporter which is fixed to one surface of the PCB and whose both ends protrude from the PCB so as to support the PCB, which are installed at both ends of the casing such that both ends of the supporter may be inserted and coupled to the left and right end caps, which have a coupling groove formed at inner sides of the left and right end caps so as to insert and couple both ends of the supporter protruding from the PCB, and which have a switch capable of controlling power provided to the LEDs formed at an outside of the left and right end caps; and
a cylindrical cover, whose both ends are coupled to the left and right end caps, which has the PCB positioned at the center of an inside of the cylindrical cover, which transmits light radiated by the LEDs of the PCB, and which is mounted onto any one surface of the casing so as to rotate in place,
wherein the casing is configured to have a rectangular stick shape or tube shape and to have a mounting surface which is formed at an upper surface of the casing, configured to be corresponding to an outer circumferential surface of the cover, configured to have a semicircular shape, and configured to be dug inwards,
the cover has both ends thereof which are couple to the left and right end caps such that the cover may be mounted onto the mounting surface of the casing and may rotate in place,
the end caps have a ring-shaped insertion coupling part such that both ends of the cover may be inserted into and coupled to the ring-shaped insertion coupling part thereby allowing the cover to rotate in place,
the cover coupled to the ring-shaped insertion coupling part to rotate in place is configured to be a white light diffusion tube such that the light may diffuse when the light radiated by the LEDs passes through the cover, the light diffusion tube has a plurality of transparent lenses that are formed in a row at a certain portion of the light diffusion tube, and the transparent lens or the light diffusion tube is positioned toward the LEDs by means of the rotation of the cover such that the LED lamp may selectively perform any one function of a lantern or a flashlight.

5. The LED lamp according to claim 4, wherein the transparent lenses are configured to be regularly spaced apart from each other at the cover along a longitudinal direction thereof and may be configured to be corresponding to the LEDs arranged at the PCB.

6. The LED lamp according to claim 4, comprising:
an outer body which helps perform a function of a flash signal light by means of insertion of the LED lamp in an emergency,
the outer body comprising:
an outer cover which consists of a material transmitting red light and is configured to have a cylindrical shape with a hollow structure in which both ends of the outer cover are opened so as to insert the LED lamp;
left and right tops which prevents the LED lamp, which is coupled to both ends of the outer cover and is inserted into the outer cover, from escaping from the outer cover; and
a tripod which is installed at the left and right tops but is foldably installed at any one of the left and right tops so as to erect the outer cover such that the light radiated by the LEDs may be expressed as a red color and may let the LED lamp perform a function of a flash signal light in the state in which the LED lamp is inserted into the outer cover,
wherein a magnet is installed at any one of the left and right tops such that the outer cover to which the left and right tops are coupled may be attached and fixed to a separate metal in the state in which the tripod is folded.
